(19) United States
(12) Patent Application Publication
(10) Pub. No.: US 2020/0309614 A1
(43) Pub. Date: Oct. 1, 2020

(54) Elastic Bearing Element

(71) Applicant: ContiTech Vibration Control GmbH, Hannover (DE)

(72) Inventors: Norbert Garbers, Dassendorf (DE); Tobias Tyroller, Regensburg (DE); Stefan Narberhaus, Garbsen (DE)

(73) Assignee: ContiTech Vibration Control GmbH, Hannover (DE)

(21) Appl. No.: 16/955,586

(22) PCT Filed: Oct. 19, 2018
(86) PCT No.: PCT/EP2018/077374

§ 371 Date: Jun. 18, 2020

(30) Foreign Application Priority Data
Dec. 19, 2017 (DE) 10 2017 223 195.5

(51) Int. Cl. G01L 1/14; F16F 1/44

(52) U.S. Cl. CPC G01L 1/142; F16F 2230/08; F16F 1/44

(57) ABSTRACT

The present invention relates to an elastic bearing element (1) having at least one first body (11), having at least one second body (12), and having at least one elastomer element (10) arranged in the direction of a force flow between the first body (11) and the second body (12), furthermore having at least one sensor (2) configured and arranged to detect directly or indirectly a force in the force flow between the first body (11) and the second body (12). The elastic bearing element (1) is characterized in that the sensor (2) comprises at least one elastic layer (20), at least one first electrode (21) and at least one second electrode (22), wherein the elastic layer (20) is arranged at least in sections between the first electrode (21) and the second electrode (22), wherein the sensor (2) is arranged in the force flow between the first body (11) and the second body (12) such that, by means of the force, the distance between the two electrodes (21, 22) can be altered and, by this means, the force can be at least partly detected, wherein the elastic layer (20) comprises a rubber mixture comprising at least one silicone rubber, as the sole rubber component, and hollow micro-spheres.

The present invention relates to an elastic bearing element as claimed in patent claim 1.

It is known to incorporate load cells and force transducers for measuring forces at the location of the elastic mounting. These sensors are arranged in addition to the elastic mounting, for example, in parallel or in series with the force flow to be detected. Conventional commercially available sensors of this type are based on SG (strain gauge) sensor technology or on piezo sensor technology, in some instances with integrated amplifiers. By way of example, it is possible to use bending beams on which SG sensor elements are adhesively bonded. Alternatively, e.g. in the case of air springs, air pressure measurements can be carried out within the air spring.

What is disadvantageous here is that an additional component is required in each case, which has to be integrated. This can lead to additional costs and necessitate additional structural space. Furthermore, the sensor may additionally need to be protected against external influences.

What is furthermore disadvantageous in the case where SG sensor elements are used is that the latter can only detect stresses or bending in a single spatial direction. This can result in erroneous measurements if at least force components in a different spatial direction occur. Eliminating this disadvantage by means of a plurality of SG sensor elements can increase the complexity and the costs both of the SG sensor elements themselves and of the electronics for evaluating and converting the stress values and thus likewise make them more expensive.

What may be disadvantageous in the case of air pressure measurement in air springs is that air is compressible and the pressure value detected may thus be lower than the force actually exerted.

What is disadvantageous in the case of pressure measurements with fluid is generally the removal of the air present in the system. In this case, venting the system often proves to be difficult, particularly if the air has to be removed as fully as possible from the system. Owing to its compressibility, the air present in an unwanted way in the system can reduce the accuracy of the measurement.

It is an object of the present invention to be able to carry out a force measurement at the location of an elastic bearing element of the type described in the introduction more easily and/or more cost-effectively and/or more accurately than has hitherto been known. In particular, the intention is to be able to dispense with additional components such as load cells, for example.

The object is achieved according to the invention by means of an elastic bearing element having the features as claimed in claim 1. Advantageous developments are described in the dependent claims.

The present invention thus relates to an elastic bearing element having at least one first body, having at least one second body, and having at least one elastomer element arranged in the direction of a force flow between the first body and the second body. The elastomer element is embodied in an elastic fashion, that is to say that it can change its shape under the action of force and revert to its original shape when the acting force is removed. Preferably, the elastomer element comprises or is formed from a vulcanized rubber mixture.

The elastic bearing element furthermore comprises at least one sensor configured and arranged to detect directly or indirectly a force in the force flow between the first body and the second body. For directly detecting the force, the sensor can be arranged between the two bodies directly in the force flow. For indirectly detecting the force, the sensor can be arranged outside the force flow, wherein forces can be transmitted to the sensor e.g. by way of a fluid arranged in the force flow. The two bodies are configured in each case to be connected to a further body in a stationary fashion, such that a force transmission can be effected by way of the elastomer element, wherein a dynamic force transmission can be damped by the elastic property of the elastomer element. The two bodies are preferably embodied in a rigid fashion, in particular from metal. The two bodies can also be referred to as stop elements.

The elastic bearing element is characterized in that the sensor comprises at least one elastic layer, at least one first electrode and at least one second electrode, wherein the elastic layer is arranged at least in sections between the first electrode and the second electrode. The elastic layer preferably comprises or is formed from an elastomeric material. The elastic layer is embodied such that it is non-electrically conductive, i.e. electrically insulating or dielectric, in order to electrically insulate the two electrodes from one another. The elastomeric material of the elastic layer preferably comprises or is formed from a vulcanized rubber mixture, wherein e.g. polyurethanes can be used as well. An electrode should be understood to mean an electron conductor which, in interplay with a second (counter-)electrode, interacts with a medium, such as here the elastic layer, situated between the two electrodes. Electrodes can comprise or consist of electrical conductors such as, e.g., metal or graphite. The electrodes can be embodied in an areal or linear fashion. By means of a sensor of this type, the distance between the two electrodes can be detected e.g. capacitively.

The sensor is arranged in the force flow between the first body and the second body such that, by means of the force, the distance between the two electrodes can be altered and, by this means, the force can be at least partly detected. In other words, the sensor is configured, by way of the distance between the two electrodes, to deduce the intensity of the force between the two bodies which alters said distance. On account of the elastic property of the elastomer element, the distance between the two electrodes can decrease as a force increases. Likewise, as the force decreases, the distance between the two electrodes can increase again back to the distance in the non-loaded state.

The elastic layer comprises a rubber mixture comprising at least one silicone rubber, as the sole rubber component, and hollow microspheres. All silicone rubbers known to a person skilled in the art can be used in this case. Preferably, silicone rubbers can be used, which can also be referred to as poly(organo)siloxanes. The latter have groups accessible to crosslinking reactions, this predominantly, but not exclusively, involving hydrogen atoms, hydroxy groups and vinyl groups, which can be situated in each case in the chain or at the ends of the chain.

Both cold crosslinking silicone rubbers (RTC=room temperature crosslinking) and hot crosslinking silicone rubbers (HTC=high temperature crosslinking) can be used. In the case of the RTC silicone rubbers, it is possible to differentiate between one- and two-component systems. The silicone rubber can also be used as a premix comprising polymer, filler and oil, as commercially available.

Particularly for setting the viscosity, the rubber mixture can additionally also comprise at least one plasticizer. All plasticizers which are known to the person skilled in the art and which are compatible with the respective silicone rubber can be used in this case. The use of silicone oil, in particular, has proved to be advantageous here since this is readily compatible with the silicone rubber. Silicone oils that undergo crosslinking have been found to be particularly well suited; they participate in the crosslinking of the rubber mixture and are often referred to as crosslinkable silicone oils. The latter result in a further significant reduction of a possible exudation of plasticizers such as has been able to be observed heretofore in the case of the insulating tubing from the prior art.

In order to increase the elasticity or the compressibility of the rubber mixture, the rubber mixture has a pore structure. At the same time the thermal or else acoustic insulation properties of the rubber mixture can be improved as a result. Said pore structure is implemented by the use of hollow microspheres that are mixed into the rubber mixture. The hollow microspheres, often also referred to simply as microspheres, are hollow spheres (microspheres) having a diameter in the p.m range made of glass, phenolic resin, carbon or thermoplastic material. They are available in expandable form, wherein they are filled with a blowing agent and expand in the course of heating, or in pre-expanded form, wherein the expansion has already been concluded. Preferably, the rubber mixture contains 2 to 200 phr microspheres, particularly preferably 2 to 30 phr, very particularly preferably 2 to 15 phr, already expanded microspheres composed of thermoplastic material, such that the rubber mixture already has a pore structure before the construction of the elastic layer or before the crosslinking.

Besides the resultant increased elasticity or compressibility of the rubber mixture, microspheres furthermore afford the advantage of the formation of a closed pore structure, which is better suited to insulation purposes owing to reduced convection in the pores. The higher the amount of expanded microspheres, the better the insulation effect becomes as a result of the higher proportion of pores. If amounts of microspheres are excessively high, however, processing engineering problems can arise when preparing or processing the mixture.

Alternatively, the rubber mixture can contain 10 to 200 phr microspheres composed of glass. With this variant it is possible to obtain a rubber mixture having higher stability in conjunction with lower elasticity or compressibility, however, since, in contrast to microspheres composed of thermoplastic material, microspheres composed of glass cannot be compressed. This reduced elasticity or compressibility, which may nevertheless be greater than in known sensors of this type, may be accepted, if appropriate, in favor of the higher stability or lifetime of the elastic layer, depending on the application.

In this case, the present invention is based on the insight that by means of a sensor of this type, on account of the comparatively high elasticity or compressibility of the elastic layer of the sensor, it is possible to create a sensor which has above-average sensitivity and which can yield correspondingly accurate measurement values. At the same time, a sensor of this type can be integrated into an elastic bearing element of this type in a simple and robust manner. In this way, a comparatively accurate measurement of the force in the force flow of an elastic bearing element of this type can be provided, without this necessitating the use of external components that may need to be protected. At the same time, a sensor of this type and respectively an elastic bearing arrangement of this type can be implemented simply and/or cost-effectively. Moreover, a sensor of this type and respectively an elastic bearing arrangement of this type can be robust vis-à-vis environmental influences such as e.g. water, moisture, dust, mud, stones and the like.

In this case, the sensor can be arranged within the elastomer element or between the elastomer element and one of the two bodies. As a result, depending on the application, it is possible to create an arrangement to enable the force of the respective force flow to be detected as effectively and accurately as possible.

It is also advantageous that it is possible to arrange a sensor of this type for directly detecting the force in the force flow between the two bodies. As a result, it is possible to dispense with a force transmission e.g. by means of a fluid.

It is furthermore advantageous that a sensor of this type can be integrated into the elastomer element or arranged at the latter as early as before the vulcanization of said elastomer element. This can simplify the production of the elastic bearing element as a whole in order to create the sensor-based function.

It is furthermore advantageous that an elastic bearing element of this type can also be created subsequently, by a sensor of this type being introduced into an existing elastic bearing element. Consequently, the properties and advantages achievable according to the invention can be retrofitted and used in existing elastic bearing elements suitable therefor.

It is also possible to use a plurality of sensors of this type, which can be embodied and arranged identically or differently. As a result, it is possible to detect measurement values at a plurality of locations independently of one another. These plurality of measurement values can be evaluated for example to the effect of identifying tiltings and/or rotations of the elastic bearing element and identifying the extent of the tilting and/or rotation.

In this case, the sensor can be embodied and arranged in all possible forms. By way of example, the sensor can be installed in a rectilinear fashion, in a curved fashion, in a spiral fashion, in a circular fashion, as an inner circle and as an outer circle, in a cruciform fashion, in a triangular fashion, in a quadrilateral fashion, etc. As a result, the detection of the force can be achieved as representatively as possible depending on the application.

In accordance with one aspect of the present invention, the sensor is embodied in a coaxial fashion, wherein the first electrode is surrounded by the elastic layer cylindrically at least in sections, preferably completely, and wherein the elastic layer is surrounded by the second electrode cylindrically at least in sections, preferably completely. As a result, the elements of the sensor can be arranged compactly in order to obtain a space-saving sensor of this type. Furthermore, it is possible to create a sensor which, on account of its rotational symmetry, can be used independently of its orientation about the longitudinal axis as an axis of the rotational symmetry since a radial distance change in any orientation results in the same alteration of the distance between the two electrodes. Consequently, the same distance change can always be detected independently of the orientation about the longitudinal axis.

In accordance with a further aspect of the present invention, the first electrode is embodied as an electrically conductive wire composed of solid material or as a multiple-stranded wire, wherein the wire preferably comprises or consists of copper, aluminum, silver or gold. A wire composed of solid material can be produced and processed in a simple manner. A multiple-stranded wire can have a higher extensibility than a wire composed of solid material, such that the sensor can withstand the force loads for a longer time and can thus have a longer service life. The materials copper, aluminum, silver or gold can have a high electrical conductivity, wherein it is necessary to weigh up between the degree of electrical conductivity, the material costs and possibly further properties of the materials depending on the application.

In accordance with a further aspect of the present invention, the second electrode is embodied as an electrically conductive layer as a film or as a braiding, a knitted fabric or a woven fabric, wherein the layer preferably comprises or consists of copper, aluminum, silver or gold. The use of a layer makes it possible to create a second electrode having the largest possible area, such that a force flow can be detected over a correspondingly large area if the layer is used at least substantially in a planar fashion. In the case where the layer of the second electrode is used in cylindrical form in the case of a sensor embodied in a coaxial fashion, the first electrode can be enclosed by the second electrode in order to create the coaxial arrangement. In any case a layer can be produced as a film simply and cost-effectively. As in the case of a multiple-stranded wire as first electrode, the alternative configuration of the layer as a braid, a knitted fabric or a woven fabric can result in a higher extensibility than in the case of a film. A braid is understood to mean a sheetlike structure created by braiding as regular interlacing of a plurality of strands of flexible material. A woven fabric is understood to mean a textile sheetlike structure composed of at least two thread systems crossed at right angles or virtually at right angles. The difference between a braid and a woven fabric is that during braiding the threads are not fed in at right angles. A knitted fabric is understood to mean a thread system produced by intermeshing.

In accordance with a further aspect of the present invention, the sensor furthermore comprises at least one protective layer arranged, preferably directly, on that side of at least one electrode, preferably of the second electrode, which faces the elastomer element. As a result, the electrode can be protected on said side. Said protective layer can serve to protect the electrode in the uninstalled state, but also to afford protection vis-à-vis the elastomer element in the installed state.

In accordance with a further aspect of the present invention, the protective layer is embodied in an electrically insulating fashion. As a result, the electrode can be electrically insulated on said side, such that an electrical sensor function can be performed better vis-à-vis a further electrode on the side facing away from the protective layer.

In accordance with a further aspect of the present invention, the protective layer is embodied in an elastic fashion, wherein the protective layer preferably comprises a silicone, particularly preferably consists of a silicone. In this way, it is possible to effect a force transmission through the protective layer in as undisturbed a manner as possible in order, despite the use of the advantageous properties of the protective layer, to influence the sensor-based detection of the force as little as possible or not at all. This can be effected simply, robustly and/or cost-effectively by the use of silicone.

In accordance with a further aspect of the present invention, at least one electrode, preferably the second electrode, is in direct contact with the elastomer element, wherein the electrode preferably comprises on the side facing the elastomer element, at least in sections, preferably completely, an adhesion promoter, preferably furthermore an adhesive elastomer mixture, thereby producing adhesion between the electrode and the elastomer element. As a result, a force transmission that is as direct and hence undisturbed as possible can be realized. The use of an adhesion promoter and optionally an additional adhesive elastomer mixture can improve the connection between the electrode and the elastomer element, such that the direct force transmission can also be increased or ensured, which can improve the accuracy of the force measurement. Moreover, the service life of the sensor can be improved as a result.

In accordance with a further aspect of the present invention, the sensor is embodied in an elongate fashion, wherein the sensor, at least in sections in the direction of its elongate extent, is arranged at least substantially transversely with respect to the direction of the force flow. An elongate sensor should be understood to mean one which extends significantly longer in one direction, namely in its longitudinal direction, than in the other two Cartesian spatial directions, namely the transverse direction and the height. When considered in cylindrical coordinates, the elongate sensor extends significantly longer in the direction of its longitudinal axis than in the radial direction. The elongate extent of the sensor enables the largest possible region within the elastomer element to be detected in a sensor-based manner, without at the same time the force transmission by the elastomer element being interrupted too much. In this case arranging the elongate sensor at least substantially, preferably exactly, transversely with respect to the direction of the force flow can make this possible with a sensor that is as short as possible. Moreover, the force of the force flow which acts perpendicularly on the sensor can be correspondingly detected directly.

In accordance with a further aspect of the present invention, the sensor extends rectilinearly at least in sections, preferably completely. This can simplify the subsequent introduction of a sensor of this type into an elastomer element since a rectilinear hole as a blind hole or as a through opening can be introduced from outside in order to accommodate the sensor. This can be done simply and rapidly in terms of production engineering e.g. by means of drilling on account of the rectilinearity of a drilled hole. Moreover, a region of the elastomer element extending as far as possible can be detected by a rectilinearly extending sensor with a sensor that is as short as possible, which can minimize the requisite costs.

In accordance with a further aspect of the present invention, the sensor extends in a ring-shaped fashion at least in sections, preferably completely. As a result, it is possible to create a comparatively large area over which the sensor can detect the force of the force flow. This can increase the accuracy of the detection.

In accordance with a further aspect of the present invention, the sensor is embodied in a divided fashion, wherein the first electrode is embodied in a continuous fashion and the second electrode is embodied in an interrupted fashion. As a result, two measurement values can be detected by one sensor, such that a force distribution can be detected, e.g. whether the loading occurs more likely on the left or on the right. At the same time, the respective force values can be used to detect the respective forces in a sensor-based manner and to calculate the difference in loading therefrom. The total force can be determined by the summation of the two individual measurement values.

In accordance with a further aspect of the present invention, the sensor is embodied such that the alteration of the distance between the two electrodes is proportional to the force of the force flow between the first body and the second body. This can be realized by way of the choice of the geometries of the electrodes and also the distance between the latter, depending on the application. A proportional relationship of distance or distance alteration and force should be understood to mean a linear relationship, which can be evaluated correspondingly simply and directly.

In accordance with a further aspect of the present invention, the sensor is embodied such that the capacitance between the two electrodes is proportional to the distance between the two electrodes. The linear relationship between the capacitance and the distance can be detected and evaluated correspondingly simply and directly.

In accordance with a further aspect of the present invention, the elastic layer of the sensor at least substantially has the same elasticity as the elastomer element. As a result, the sensor can be arranged in the force flow in such a way that the force can be detected as representatively as possible because, on account of the same elasticity of the elastomer element and of the sensor, the same force can also flow through the sensor as through the elastomer element. This can increase the quality of the detected sensor signal and also simplify the evaluation.

A plurality of exemplary embodiments of the present invention are explained below in association with the following figures. In the figures:

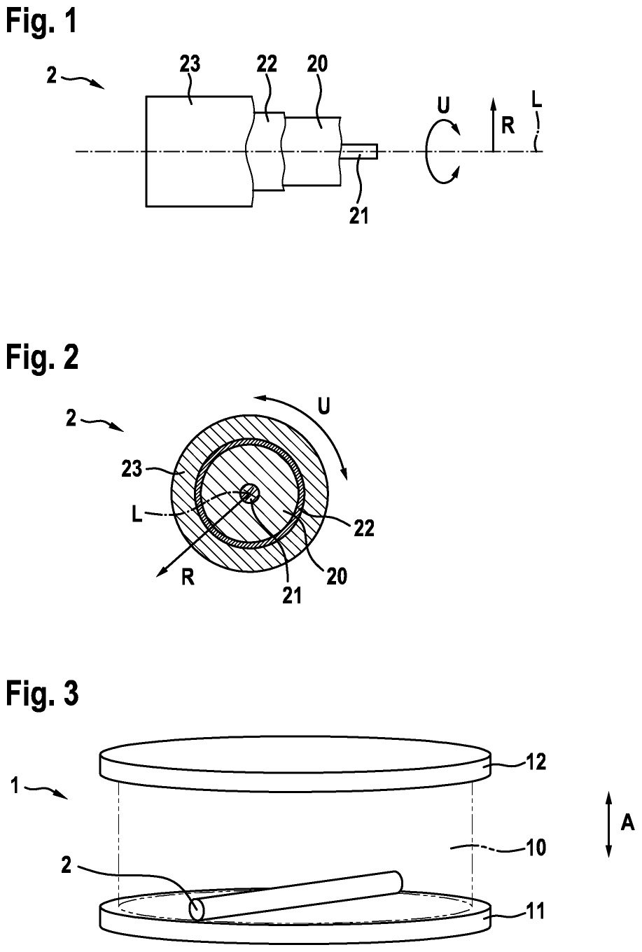

FIG. 1 shows a schematic longitudinal section through a sensor of an elastic bearing element according to the invention;

FIG. 2 shows a schematic cross section of FIG. 1;

FIG. 3 shows a perspective illustration of an elastic bearing element according to the invention in accordance with a first exemplary embodiment;

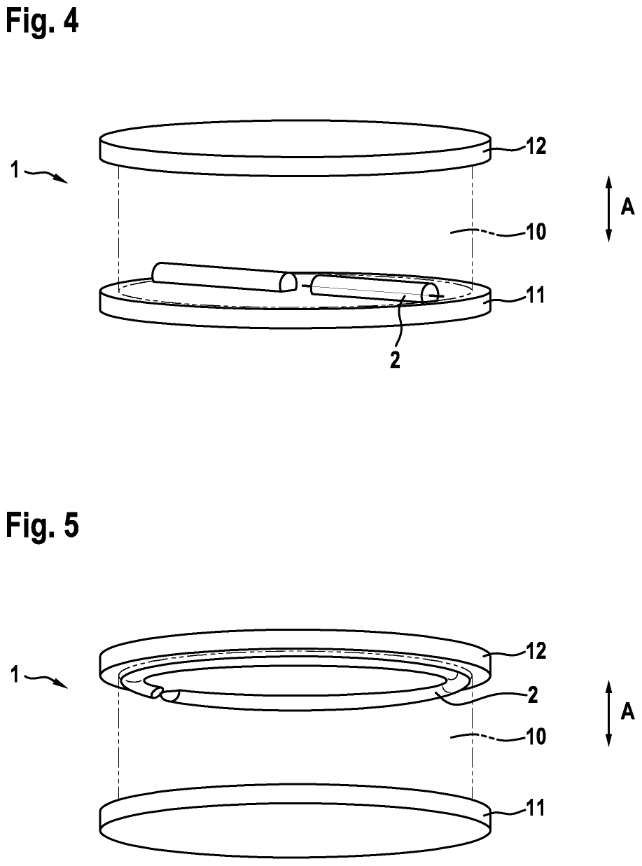

FIG. 4 shows a perspective illustration of an elastic bearing element according to the invention in accordance with a second exemplary embodiment; and

FIG. 5 shows a perspective illustration of an elastic bearing element according to the invention in accordance with a third exemplary embodiment.

FIG. 1 shows a schematic longitudinal section through a sensor 2 of an elastic bearing element 1 according to the invention. FIG. 2 shows a schematic cross section of FIG. 1. The sensor 2 extends in an elongate fashion along its longitudinal axis L, from which a radial direction R extends away perpendicularly. Radially on the inside, the sensor 2 comprises a first electrode 21, which can also be referred to as inner electrode 21. A cylindrical elastic layer 20 is arranged radially around the first electrode 21, said elastic layer enclosing the first electrode 21 in the circumferential direction U. The elastic layer 20 is enclosed radially on the outside by a second electrode 22 in the circumferential direction U.

The two electrodes 21, 22 are embodied in an electrically conductive fashion and are contacted (not illustrated) from outside in the direction of the longitudinal axis L. The intervening layer 20 is embodied in an elastic and electrically insulating fashion, such that e.g. a capacitance between the two electrodes 21, 22 can be detected. If, in this case, a force or a pressure is exerted on the second electrode 22 from outside, then the radial distance between the two electrodes 21, 22 is reduced at this point. This can be detected by way of a corresponding change in the capacitance and can be converted into a force or pressure value, respectively, such that the sensor 2 can also be referred to as a force or pressure sensor 2.

In this case, the elastic layer 20 comprises a rubber mixture comprising at least one silicone rubber, as the sole rubber component, and hollow microspheres. As a result, it is possible to create an elastic, electrically insulating layer 20 between the two electrodes 21, 22, said layer additionally also having good compressibility, such that even small forces can be detected in a sensor-based manner with comparatively high accuracy.

Optionally and as illustrated in FIGS. 1 and 2, the second electrode 22 is enclosed by a ring-shaped protective layer 23 in the circumferential direction U for protection against external influences. The protective layer 23 is formed from a silicone mixture in an elastic and electrically insulating fashion. The protective layer 23 can also be dispensed with.

FIG. 3 shows a perspective illustration of an elastic bearing element 1 according to the invention in accordance with a first exemplary embodiment. In this case, a sensor 2 is arranged rectilinear and perpendicularly to the main resilient deflection direction A of the elastic bearing element 1 in a manner integrated into the latter. In this case, the elastic bearing element 1 comprises an elastomer body 10 in the form of a rubber spring 10 arranged between a first body 11 as lower stop element 11 and a second body 12 as upper stop element 12. In this case, the sensor 2 is arranged within the elastomer body 10 in such a way that forces from the force flow in the main resilient deflection direction A of the elastomer body 10 can be detected in a sensor-based manner as described above.

FIG. 4 shows a perspective illustration of an elastic bearing element 1 according to the invention in accordance with a second exemplary embodiment. In this case, the sensor 2 is embodied in an interrupted fashion, wherein the first electrode 21 is embodied in a continuous fashion.

FIG. 5 shows a perspective illustration of an elastic bearing element 1 according to the invention in accordance with a third exemplary embodiment. In this case, the sensor 2 is arranged in a ring-shaped fashion in order to enlarge the sensor-based effective area.

### LIST OF REFERENCE SIGNS (PART OF THE DESCRIPTION)

A Main resilient deflection direction of the elastic bearing element 1

L Longitudinal axis

R Radial direction

U Circumferential direction

1 Elastic bearing element

10 Elastomer element; rubber spring

11 First body; lower stop element

12 Second body; upper stop element

2 Sensor; pressure sensor; force sensor

20 Elastic layer; rubber mixture

21 First electrode; inner electrode

22 Second electrode; outer electrode

23 Protective layer

1.-15. (canceled)

16. An elastic bearing element comprising:
a first body,
a second body,
an elastomer element arranged in the direction of a force flow between the first body and the second body,
a sensor configured and arranged to detect directly or indirectly a force in the force flow between the first body and the second body,
wherein the sensor comprises;
an elastic layer,
a first electrode and
a second electrode,
wherein the elastic layer is arranged in sections between the first electrode and the second electrode,
wherein the sensor is arranged in the force flow between the first body and the second body such that, by means of the force, the distance between the two electrodes can be altered and the force between the first electrode and the second electrode is at least partly detected, and
wherein the elastic layer comprises a rubber mixture comprising at least one silicone rubber, as the sole rubber component, and hollow microspheres.

17. The elastic bearing element as claimed in claim 16, wherein the sensor is embodied in a coaxial fashion and wherein the first electrode is surrounded by the elastic layer cylindrically and
wherein the elastic layer is surrounded by the second electrode cylindrically.

18. The elastic bearing element as claimed in claim 17, wherein the first electrode is embodied as an electrically conductive wire composed of solid material or as a multiple-stranded wire, wherein the wire comprises copper, aluminum, silver or gold.

19. The elastic bearing element as claimed in claim 17, wherein the second electrode is embodied as an electrically conductive layer as a film or as a braiding, a knitted fabric or a woven fabric, and where the layer comprises or consists of copper, aluminum, silver or gold.

20. The elastic bearing element as claimed in claim 16, wherein the sensor comprises at least one protective layer arranged directly on that side the second electrode.

21. The elastic bearing element as claimed in claim 20, wherein the protective layer is embodied in an electrically insulating fashion.

22. The elastic bearing element as claimed in claim 20, wherein the protective layer is embodied in an elastic fashion and wherein the protective layer comprises a silicone.

23. The elastic bearing element as claimed in claim 16, wherein the second electrode is in direct contact with the elastomer element, wherein the second electrode comprises, on the side facing the elastomer element, an adhesion promoter, thereby producing adhesion be-tween the second electrode and the elastomer element.

24. The elastic bearing element as claimed in claim 16, wherein the sensor is embodied in an elongate fashion, wherein the sensor, in the direction of its elongate extent, is arranged at least substantially transversely with respect to the direction of the force flow.

25. The elastic bearing element as claimed in claim 24, wherein the sensor extends rectilinearly.

26. The elastic bearing element as claimed in claim 24, wherein the sensor extends in a ring-shaped fashion.

27. The elastic bearing element as claimed in claim 16, wherein the sensor is embodied in a divided fashion, and wherein the first electrode is embodied in a continuous fashion and the second electrode is embodied in an interrupted fashion.

28. The elastic bearing element as claimed in claim 16, wherein the sensor is embodied such that the alteration of the distance between the first and second electrodes is proportional to the force of the force flow between the first body and the second body.

29. The elastic bearing element as claimed in claim 16, wherein the sensor is embodied such that the capacitance between the first and second electrodes is proportional to the distance between the first and second electrodes.

30. The elastic bearing element as claimed in claim 16, wherein the elastic layer of the sensor at least substantially has the same elasticity as the elastomer element.

31. The elastic bearing element as claimed in claim 16, wherein the sensor is configured to detect a capacitance change based on the force applied to the second electrode and to determine a pressure value based on the detected capacitance change.

32. A sensor for a bearing element, the sensor comprising:
a first electrode arranged on a longitudinal direction;
an elastic layer formed on the first electrode;
a second electrode formed on the elastic layer;
a cover layer formed on the second electrode;
wherein the sensor is configured to detect a capacitance change between the first electrode and the second electrode based on radial movement of the second electrode and to determine a pressure based on the detected capacitance.

33. The sensor of claim 32, wherein the sensor is attached to a first body of the bearing element to detect pressure between the first body and a second body of the bearing element.

34. The sensor of claim 33, wherein the sensor is arranged in a circular fashion on the first body.
